(19) United States
(12) Patent Application Publication
(10) Pub. No.: US 2024/0211734 A1
(43) Pub. Date: Jun. 27, 2024

(54) HIERARCHICAL FRAMING TRANSFORMER FOR ACTIVITY DETECTION

(71) Applicant: SRI International, Menlo Park, CA (US)

(72) Inventor: Richard J. Rohwer, San Diego, CA (US)

(21) Appl. No.: 18/545,217

(22) Filed: Dec. 19, 2023

Related U.S. Application Data
(60) Provisional application No. 63/476,857, filed on Dec. 22, 2022.

(51) Int. Cl. G06N 3/0455; G06N 3/088

(52) U.S. Cl. CPC G06N 3/0455; G06N 3/088

(57) ABSTRACT

In general, various aspects of the techniques are directed to a hierarchical framing transformer for activity detection. A computing system comprising a memory and processing circuitry may implement the techniques. The memory may store a plurality of input vectors representative of time-series data. The processing circuitry may implement an unsupervised machine learning transformer, where the unsupervised machine learning transformer is configured to process the plurality of input vectors to obtain a sequence of time ordered segments that maintain a time order of the plurality of input vectors. The unsupervised machine learning transformer may also encode the sequence of time ordered segments to obtain a single semantic embedding vector that identifies an activity occurring over at least a portion of the time-series data represented by the plurality of input vectors, and output an indication of the activity detected based on the semantic embedding vector.

This application claims the benefit of U.S. Provisional Application No. 63/476,857, entitled “HIERARCHICAL FRAMING TRANSFORMER,” filed Dec. 22, 2022, the entire contents of which are hereby incorporated by reference.

### TECHNICAL FIELD

This disclosure is related to computing systems, and more specifically to automatically detecting activities by computing systems.

### BACKGROUND

Activity detection is a class of computing algorithms that identify an activity. One such activity is referred to as an anomaly, where such computing algorithms for performing anomaly detection may detect the anomaly in terms of statical analysis of underlying data that exceed standard deviations or otherwise represent outliers. A computing system may employ one or more statistical models (possibly in the form of, or incorporating, one or more machine learned models) that consider data and identify portions of the data that may represent the anomaly (or other activity).

Anomaly detection (which is a subset of activity detection) is a distinct problem having wide applicability in a number of different areas. For example, a computing system monitoring network behavior may apply anomaly detection to identify network metric data representative of an anomaly. In the context of network monitoring, such anomalies may facilitate troubleshooting of network configuration, malicious attacks (e.g., network intrusions, denial of service attacks, etc.), or other network issues. Anomaly detection can be applied to images to detect suspicious behavior, image altercation, medical abnormalities, manufacturing defects, and the like. Anomaly detection can, as another example, be applied to financial data to detect fraud or other malicious financial behavior.

Anomaly detection algorithms may incorporate one or more machine learning models that are generally trained via unsupervised learning given that anomalies are random and rarely labeled, and thus provide a small set of training examples by which to perform supervised learning. That is, there is a large set of “normal” training examples, but only a small number (relative to the number of “normal” training examples) of “abnormal” training examples usable for identifying anomalies. Machine learned models trained for anomaly detection are typically applied to large amounts of data captured at a particular time and may be inefficient at detecting anomalies that occurs over periods of time due to the large amounts of data collected at each sampling period. As such, real-time anomaly detection using machine learning models may be well suited to a static snapshot of data at a particular time, but not well adapted for identifying anomalies (which is one type of activities) that occur over longer durations of time.

### SUMMARY

In general, various aspects of the techniques described in this disclosure may enable computing systems to employ a hierarchical framing transformer (HFT) for anomaly detection that applies to time-series data. While transformers may allow for the underlying time-series data to be represented as a hierarchy of activities (or, in other words, activities represented at different levels of abstraction) and identify different activities between the different levels of abstraction, transformers may generally be inefficient at identifying time-based order between different activities. In other words, transformers may not be conditioned for time-series data.

In order to overcome the lack of conditioning for time-series data, the HFT may perform segmentation over time to identify different time sequences in which various activities occurred. The HFT may then process the sequentially ordered activities in order to detect anomalies or other outlier activities. Stated differently, the HFT may first determine sequences of activities at various levels of abstraction (over time and space, not solely in space for a given time as would be the case in, as one example, visual image processing). The HFT may next determine anomalies or other activities between the sequences of activities at the different levels of abstraction. The HFT is trained to detect such activities (e.g., anomalies) by disregarding (which is a way to refer to de-weighting) certain inputs to the HFT while emphasizing (which is a way to refer to weighting) different inputs to the HFT, where the HFT is trained to process the sequences of activities as the inputs and maintain order between sequences of activities in order to detect the anomalies occurring over time.

The HFT may also be trained via unsupervised learning in which the HFT effectively trains itself while still potentially achieving high rates of anomaly detection over time series data that may represent activities performed in and space (e.g., location) over time. The HFT may divide the activities into lower levels of abstraction and process these activities at the different levels of abstraction to identify anomalies at the different levels of abstraction. Segmentation enables the HFT to preserve order between the activities at the different levels of abstraction, while still allowing for unsupervised learning. As such, the HFT adapted according to various aspects of the techniques described in this disclosure may be adapted to perform activity detection for time-series data.

In this respect, HFTs implemented in accordance with various aspects of the techniques may improve operation of a computing system itself. By enabling HFTs to preserve time-based order, HFTs may identify activities (such as anomalies) over time that would otherwise be unidentified. Segmenting the time-series data into discrete timeframes and maintaining this order may enable computing systems to more accurately detect anomalies (which are one example of activities) that occur over time and space. Such activity detection may enable the computing system to better identify anomalous activities over time of life tracking for detecting, as an example, anomalous human behaviors. But such activity detection may also apply to financial contexts, machine conditioning monitoring, and/or any other context involving time-series data.

In some examples, various aspects of the techniques are directed to a computing system configured to perform activity detection, the computing system comprising: a memory configured to store a plurality of input vectors representative of time-series data; processing circuitry coupled to the memory, and configured to implement an unsupervised machine learning transformer, wherein the unsupervised machine learning transformer is configured to: process the plurality of input vectors to obtain a sequence of time ordered segments that maintain a time order of the plurality of input vectors; encode the sequence of time ordered segments to obtain a single semantic embedding vector that identifies an activity occurring over at least a portion of the time-series data represented by the plurality of input vectors; and output an indication of the activity detected based on the semantic embedding vector.

In another example, various aspects of the techniques are directed to a method of performing activity detection, the method comprising: processing, by an unsupervised machine learning transformer executed by a computing system, a plurality of input vectors representative of time-series data to obtain a sequence of time ordered segments that maintain time order of the plurality of input vectors; encoding, by the unsupervised machine learning transformer, the sequence of time ordered segments to obtain a single semantic embedding vector that identifies an overarching activity occurring over at least a portion of the time-series data represented by the plurality of input vectors; and outputting, by the unsupervised machine learning transformer, an indication of an activity detected based on the semantic embedding vector.

In another example, various aspects of the techniques are directed to a non-transitory computer-readable storage medium having instructions stored thereon that, when executed, cause one or more processors to: invoke an unsupervised machine learning transformer that: processes a plurality of input vectors representative of time-series data to obtain a sequence of time ordered segments that maintain time order of the plurality of input vectors; encodes the sequence of time ordered segments to obtain a single semantic embedding vector that identifies an overarching activity occurring over at least a portion of the time-series data represented by the plurality of input vectors; and outputs the semantic embedding vector.

### BRIEF DESCRIPTION OF DRAWINGS

FIG. 1 is a block diagram illustrating an example computing system for applying a hierarchical framing transformer for activity detection, in accordance with one or more techniques of the disclosure.

FIG. 2 is a conceptual diagram illustrating an example trajectory segmentation performed by the hierarchical framing transformer of FIG. 1, in accordance with one or more techniques of the disclosure.

FIGS. 3A and 3B are conceptual diagrams illustrating example modifications made to a standard transformer attention mechanism for a Hierarchical Framing Transformer (HFT), in accordance with one or more techniques of the disclosure.

FIG. 4 is a conceptual diagram illustrating multiheaded generalization of the HFT attention mechanism of FIGS. 3A and 3B, in accordance with one or more techniques of the disclosure.

FIG. 5 is a flowchart illustrating example operation of the computing system of FIG. 1 in applying a hierarchical framing transformer for activity detection in accordance with various aspects of the techniques described in this disclosure.

Like reference characters denote like elements throughout the text and figures.

### DETAILED DESCRIPTION

The Hierarchical Framing Transformer (HFT) includes an unsupervised neural network algorithm for partitioning a series of vectors into consecutive segments, with each segment exhibiting some potentially meaningful coherent activity. Each segment is also assigned a learned semantic vector representation of the segment's meaning. With each segment replaced by the respective segments representing vector, the HFT obtains a new shorter series of vectors on which the process is repeated, yielding ever more abstract activities until the entire series is represented by a single vector. This process of reducing series to vectors can be approximately reversed to stochastically generate segments or entire series that may plausibly instantiate any given semantic vector. One example use of this HFT algorithm may map vector series into a semantic embedding space to facilitate outlier (or in other words, anomaly) detection, and to use the generation capability to generate series that do not appear to be anomalous. However, the ability to, in effect, perform unsupervised parsing of arbitrary series has numerous and diverse potential applications.

One challenge to which this HFT algorithm may be applied is to classify human trajectories as anomalous or not, which in turn presents the challenge of automatically reducing a trajectory to a form that conveniently supports outlier detection. The techniques described in this disclosure may meet this challenge and goes further by automatically breaking a trajectory into a sequence of segments, each corresponding to a meaningful activity. The activities are hierarchical, meaning that a sequence of activities at one level of the hierarchy may constitute a single activity at a higher level. The hierarchy is grounded in a lowest level of activity computed directly from single positions or short sequences of positions in the raw trajectory data, together with ancillary information such as annotation at that position on a map, the identity of the traveler, the date and time, and/or other information that may aid understanding the trajectory and the purpose of the trajectory. The techniques set forth in this disclosure are unsupervised, meaning that the model learns how to construct the hierarchy of segments given only a dataset of trajectory examples without any labeling specifying how the dataset of trajectory examples should be divided into segments, although such labeling may be usefully employed if available.

Although motivated by its application to human trajectory data (such as can be collected from global positioning system—GPS—systems in mobile cellular phones), these techniques are applicable to the broad class of time series applications in which the time series data is usefully regarded in terms of a hierarchy of episodic segments. The HFT algorithm is not limited to anomaly detection applications, where the HFT algorithm role in this use case is to convert the trajectory data into a form that is highly suited to further activity detection (such as anomaly detection) processing. This HFT algorithm is also suited to many other applications that involve discovering, understanding, or reasoning about latent hierarchical episodic structure in time series data.

The techniques set forth in this disclosure employs the HFT to divide trajectories (which is an example of time-series data in the form of GPS) into meaningful segments and assigns an embedding vector to represent the meaning of each segment. The sequence is thereby converted into a shorter sequence of vectors that represent more activities at different levels of abstraction. A modified transformer attention mechanism is used to define the segments. This process is applied hierarchically, eventually producing a single vector representing the entire sequence. These layers of the transformer constitute its encoder.

The encoder may be followed by a decoder that hierarchically reproduces the input vector sequences, forming an auto-encoder. The HFT model is trained with a loss function that measures how well each sequence generated by the decoder matches the input to the encoder. Each encoder layer produces output of a specific length, regardless of the length of its input sequence. When training, the corresponding decoder layer is constrained to produce a sequence of the same length so that the output of the final decoder layer may be aligned with the input. Each encoder layer has the same overall structure, and likewise for the decoder layers, but these two structures differ somewhat in order to handle the fact that the encoder reduces sequence length while the decoder lengthens sequences. The generic encoder layer has three variants: deterministic, variational, and information-driven variational. There is just one generic decoder layer architecture, which is variational. The information-driven variational encoder may, in some examples, be trained by an information maximization principle without using a decoder to form an auto-encoder.

The transformer attention mechanism is modified to learn framing:
(1) Map sequences of vectors into slots of a template, one slot per segment; and
(2) To do so while preserving the sequential order of segments in the order of the slots.

An information maximization process enables the transformer encoder layers to be learned without using a decoder within an auto-encoder framework. An aligned overlap procedure enables long sequences to be analyzed in shorter overlapping pieces. The decoder uses a Gaussian process to expand the template slots into sequence segments. Breaking time series into meaningful segments has numerous applications in the motivating domain of pattern-of-life analysis, but is applicable to time-series problems generally. Such problem areas include natural language processing, financial time series analysis, and condition monitoring for machinery.

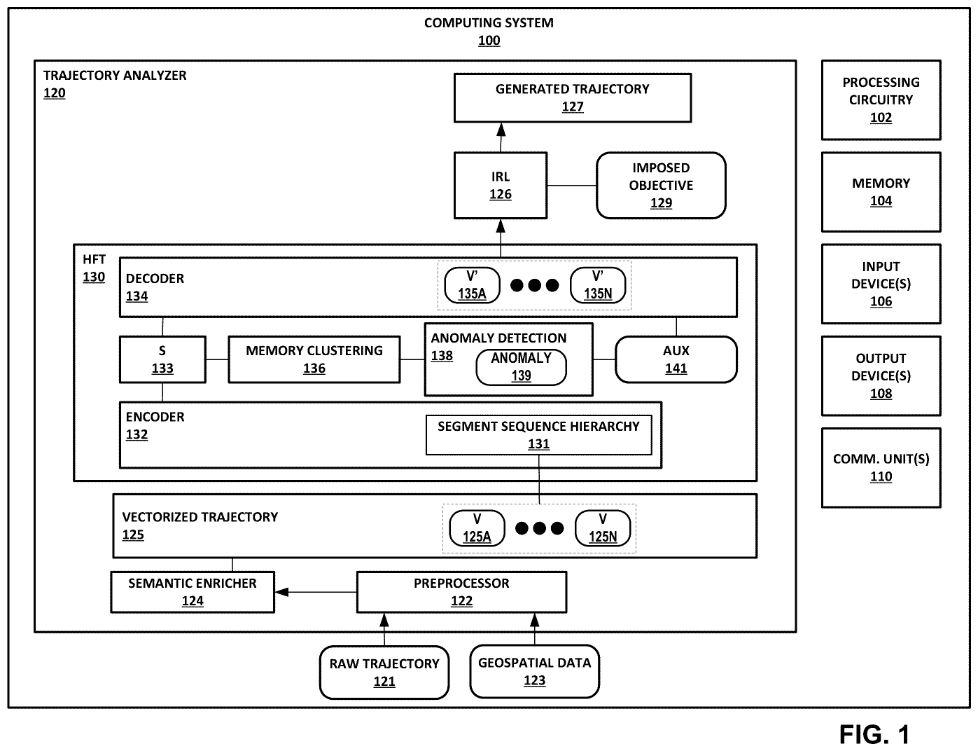

FIG. 1 is a block diagram illustrating an example computing system for applying a hierarchical framing transformer for activity detection in accordance with one or more techniques of the disclosure. Computing system 100 represents one or more computing devices, including distributed or cloud-based computing system that coordinate execution across multiple computing devices (e.g., possibly in the form of virtual machines or other virtual execution environments). As shown in the example of FIG. 1, computing system 100 includes processing circuitry 102, a memory 104, one or more input device(s) 106, one or more output device(s) 108, and one or more communication (“COMM.”) unit(s) 110.

Processing circuitry 102 may represent any type of processing circuitry that implements functionality, either by way of discrete hardware logic or through execution of software. Processors 102 may include a microprocessor, a controller, a digital signal processor (DSP), a central processing unit (CPU), a graphics processing unit (GPU), an application specific integrated circuit (ASIC), a field-programmable gate array (FPGA), or equivalent discrete or integrated logic circuitry. The functions attributed to processors 102 in this disclosure may be embodied as software, firmware, hardware and combinations thereof.

Memory 104 may store information for processing during operation of computing system 100. In some examples, memory 104 may include temporary memories, meaning that a primary purpose of the one or more storage devices is not long-term. Memory 104 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 104, in some examples, also includes one or more computer-readable storage media. Memory 104 may be configured to store larger amounts of information than volatile memory. Memory 104 may further be configured for long-term storage of information as non-volatile memory space and retain information after activate/off cycles. Examples of non-volatile memories include magnetic hard disks, optical discs, floppy disks, solid state drives (SSDs), Flash memories, or forms of electrically programmable memories (EPROM) or electrically erasable and programmable (EEPROM) memories. Memory 104 may store program instructions and/or data associated with one or more of the components described in accordance with one or more aspects of this disclosure.

Processing circuitry 102 and memory 104 may be operatively coupled to one another and provide an operating environment or platform for computing system 100, which may be implemented as software, but may in some examples include any combination of hardware, firmware, and software. Processing circuitry 102 may execute instructions and memory 104 may store instructions and/or data of one or more components or modules. The combination of processing circuitry 102 and memory 104 may retrieve, store, and/or execute the instructions and/or data of one or more applications, components, modules, or software. Processing circuitry 102 and memory 104 may also be operably coupled to one or more other software and/or hardware components, including, but not limited to, one or more of the components illustrated in FIG. 1. Computing system 100 may use processing circuitry 102 to perform operations in accordance with one or more aspects of the present disclosure using software, hardware, firmware, or a mixture of hardware, software, and firmware residing in and/or executing at computing system 100, and may be distributed among one or more devices. One or more storage devices of memory 104 may be distributed among one or more devices.

Computing system 100 may perform operations for some or all of the components of trajectory analyzer 120 described herein using software, hardware, firmware, or a mixture of hardware, software, and firmware residing in and/or executing at computing system 100. Computing system 100 may execute each of the component(s) with multiple processors or multiple devices. Computing system 100 may execute one or more of such components as part of a virtual machine or container executing on underlying hardware. One or more of such components may execute as one or more services of an operating system or computing platform. One or more of such components may execute as one or more executable programs at an application layer of a computing platform. One or more components of computing system 100 may represent data stored locally with devices that include processing circuitry 102 or stored remote at a cloud or other remote storage system.

Computing system 100 comprises any suitable computing system having one or more computing devices, such as real or virtual servers, compute nodes, desktop computers, laptop computers, gaming consoles, smart televisions, handheld devices, tablets, mobile telephones, smartphones, etc. In some examples, at least a portion of computing system 100 is distributed across a cloud computing system, a data center, and/or across a network, such as the Internet, another public or private communications network, for instance, broadband, cellular, Wi-Fi, and/or other types of communication networks, for transmitting data between computing systems, servers, and computing devices.

One or more input devices 106 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 106 of computing system 100 may generate, transmit, or process output. Examples of output are tactile, audio, visual, and/or video output. Output devices 108 may include a display, sound card, video graphics adapter card, speaker, presence-sensitive screen, one or more USB interfaces, video and/or audio output interfaces, or any other type of device capable of generating tactile, audio, video, or other output. Output devices 108 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 106 and one or more output devices 108.

One or more communication units 110 of computing system 100 may communicate with devices external to computing system 100 (or among separate computing devices of computing system 100) by transmitting and/or receiving data and may operate, in some respects, as both an input device and an output device. In some examples, communication units 110 may communicate with other devices over a network. In other examples, communication units 110 may send and/or receive radio signals on a radio network such as a cellular radio network. Examples of communication units 110 include a network interface card (e.g., such as an Ethernet card), an optical transceiver, a radio frequency transceiver, a GPS receiver, or any other type of device that can send and/or receive information. Other examples of communication units 110 may include Bluetooth®, GPS, 3G, 4G, and Wi-Fi® radios found in mobile devices as well as Universal Serial Bus (USB) controllers and the like.

Processing circuitry 102 and memory 104 may, as noted above, provide an execution environment configured to support execution of a trajectory analyzer 120. Trajectory analyzer 120 may represent a unit configured to analyze raw trajectory data 121 (which is one example of time-series data, and is referred to herein and shown in the example of FIG. 1 as “raw trajectory 121”) in order to identify anomalies in pattern-of-life analysis. Raw trajectory data 121 may, as an example, represent a sequential series of coordinates, such as GPS coordinates collected via a cellular phone (such as a smartphone), GPS handset, GPS tracker (e.g., such as those installed in cars for determining driving habits), or any other device capable of producing GPS coordinates. While described with respect to GPS coordinates, any conceivable type of raw trajectory 121 may be used, including time of travel, direction, velocity, distance, etc.

Trajectory analyzer 120 may process raw trajectory 121 along with, in the example of FIG. 1, geospatial data 123, which may refer to map data identifying locations, names of locations, types of locations, etc. Trajectory analyzer 120 may process raw trajectory 121 along with geospatial data 123 to identify anomalies (which are one example of activities) in support of pattern of life analyses. Trajectory analyzer 120 may output a generated trajectory 125, which may recommend how raw trajectory 121 may be adapted to preserve or reduce an activity, where in the case of anomaly detection may identify generated trajectory 125 that would reduce the anomalous behavior (e.g., in the case of automobile trajectories for purposes of auto insurance, generated trajectory 125 may avoid negative insurance adjustments by improving safety with respect to the anomalous behavior).

Trajectory analyzer 120 may employ any number of different activity detection models, including machine learning models. To provide a few examples, trajectory analyzer 120 may implement one or more of a replicator neural network, an autoencoder, a variational autoencoder, a long short-term memory (LSTM) neural networks, Bayesian networks, Hidden Markov models (HMMs), a convolutional neural network (CNN), and/or a simple recurrent unit (SRU). However, some of these example machine learning models are not conditioned for time-series data, such as raw trajectory 121, and are designed for a static snapshot in time. Such conditioning of machine learning models may take an inordinate amount of time to adapt the machine learning model to accommodate time-series data, particularly when anomaly detection (which is one example form of activity detection) is required across the entirety of the time-series data (meaning that the anomaly occurs as a result of a sequence of activities rather than any given activity of the sequence of activities.

To illustrate, one type of machine learning model, denoted above as a variational autoencoder (VAE), arose out of developments in natural language processing (NLP) in the context of translation between different natural languages. While NLP may require some 11 semblance of sequential ordering of words, translation between different natural languages is generally time order independent, meaning that the VAE is not conditioned to maintain time order of the words. While the VAE is generally good at generating a hierarchical representation of the words, then phrases, then sentences, then paragraphs, etc., reducing a paragraph into a single representative semantic embedding vector of the selected text undergoing translation that would be suitable for trajectory analysis in pursuit of activity detection, the VAE is not conditioned for pattern of life analysis with respect to time-series data as the VAE has no concept of sequential ordering.

In accordance with various aspects of the techniques described in this disclosure, trajectory analyzer 120 may employ a hierarchical framing transformer (HFT) 130 for anomaly detection that applies to time-series data (which again is represented in the example of FIG. 1 as raw trajectory 121). In order to overcome the lack of conditioning for time-series data, HFT 130 may first perform segmentation over time to identify different sequences of time-ordered segments in which various activities occurred prior to application of an autoencoder or a VAE. That is, HFT 130 may include an encoder 132 and a decoder 134 that operates as a VAE that has been adapted to process sequences of time-ordered segments and thereby preserve time ordered processing.

HFT 130 may then process the sequentially ordered activities via encoder 132 in order to detect anomalies or other outlier activities. Stated differently, HFT 130 may first determine sequences of activities at various levels of abstraction (over time and space, not solely in space for a given time as would be the case in, as one example, visual image processing). HFT 130 may next determine anomalies or other activities between the sequences of activities at the different levels of abstraction. HFT 130 is trained to detect such activities or other anomalies by disregarding (which is a way to refer to de-weighting) certain inputs to HFT 130 while emphasizing (which is a way to refer to weighting) different inputs to HFT 130, where HFT 130 is trained to process the sequences of activities as the inputs and maintain order between sequences of activities in order to detect the anomalies.

HFT 130 may also be trained via unsupervised learning in which HFT 130 effectively trains itself while still potentially achieving high rates of anomaly detection over raw trajectory 121 that may represent activities performed in both time and space (e.g., location). HFT 130 may divide the activities into lower levels of abstraction and process these activities at the different levels of abstraction to identify anomalies at the different levels of abstraction. Segmentation enables HFT 130 to preserve order between the activities at the different levels of abstraction, while still allowing for unsupervised learning. As such, HFT 130 configured to perform various aspects of the techniques described in this disclosure may be adapted to perform activity detection for raw trajectory 121.

Trajectory analyzer 120 may, in addition to HFT 130, include a preprocessor 122, a semantic enricher 124, and an inverse reinforcement learning (IRL) model 126. In some aspects, computing system 100 includes processing circuitry 102 and a memory 104 that can store and/or execute components of trajectory analyzer 120. Such components may include preprocessor 122, semantic enricher 124, IRL 126, and HFT 130 that may form an overall framework for performing one or more techniques described herein.

Preprocessor 122 may align geospatial data 123 with trajectories 121 (which is another way to refer to raw trajectory 121) and merged into a multi-resolution graph (MRG) data structure that handles variations in the density of activity across space and time efficiently. Semantic enrichment module 104 then uses a graph neural network (GNN) to associate semantic embedding vectors with each location and time indexed by the MRG. These vectors represent types of locations (road, shop) and times (holidays, rush hours). Any given trajectory is converted to a sequence of embedding supervision vectors by reading them off the MRG for each location and time in the trajectory to create vectorized trajectory 125 (V₁, V₂, . . . , Vₙ), which is shown in the example of FIG. 1 as V 125A-125N (where vectorized trajectory 125 comprised of V 125A-125N may also be referred to as “V 125”).

In this respect, preprocessor 122 may perform preprocessing of raw trajectory 121 and geospatial data 123 (in this example) to obtain preprocessed embedded vectors. Preprocessor 122 may output preprocessed embedded vectors to semantic enricher 124, which may perform semantic enrichment with respect to the preprocessed embedded vectors to generate input vectors 125. As such, one or more or both of preprocessor 122 and semantic enricher 124 may condition raw trajectory 121 during generation of input vectors 125.

HFT 130 receives V 125 as input. Encoder 132 frames the steps of trajectory represented by V 125 (which need not be uniform in time) into a sequence 131 of segments (S₁, S₂, . . . , Sₘ), (m<n), producing a semantic embedding vector for each segment that represents the type of activity then taking place. The resulting sequence of segments 131 (which is another way to refer to sequence 131, that is shown as segment sequence hierarchy 131 in the example of FIG. 1) is similarly divided at the next level of the hierarchy, until a final layer where a single vector represents an entire trajectory 121, and its semantic embedding vector 133 (shown as “S 133” in the example of FIG. 1) represents the generally complex, highly abstract activity exhibited by whole trajectory 121, e.g., a set of coordinated trajectories.

In this respect, HFT 130 may process V 135 to obtain sequence 131 of time ordered segments that maintain time order of V 135. HFT 130 may next apply encoder 132 (which represents an example of an unsupervised machine learning transformer) to sequence 131 of the time ordered segments and obtain a single semantic embedding vector S 133 that identifies an overarching activity over at least a portion of the trajectory 121 represented by V 125. As used here, the term “obtain” encompasses the terms “generate” and “compute”.

Mathematically, HFT 130 accepts a sequence of vectors 125, which are defined as

$${V}^{0} = ( {v}_{1} , … , {v}_{{V}^{0}} )$$

of a given dimension dⁱⁿ as input. The length of the sequence T_{V}⁰ can be any strictly positive integer, and may vary between sequences as its sequence-valued subscript suggests (in practice, sequences are distinguished from one another by introducing integer-valued indices for them and defining conceptually less direct but notationally simpler expressions such as Vⱼ⁰=(v₁, . . . , v_{Tj})). A maximum allowed length may be chosen during design and extend all the sequences of interest to that length using a padding scheme suited to the application in order to potentially facilitate feeding batches of sequences into array-processing equipment such as GPUs. HFT design neither requires nor prohibits such an arrangement.

HFT 130 is not concerned with the manner in which these vector sequences 125 are produced, but an illustrative example can illuminate operation of various techniques of HFT 130. As one example, consider a human trajectory consisting of (position, time) samples X=((x₁,t₁), . . . , (x_{Tx}, t_{Tx})). From these it is possible to derive features such as velocity and acceleration estimates, and dwell times at or near particular locations. These may be concatenated to form the HFT input vectors V⁰ (shown as V 125). In isolation, however, absolute locations such as (latitude, longitude) readings are not very informative for human mobility applications. It is usually more important to know what landforms or infrastructure are present at these locations. Given map data that provides such information, the locations can be converted to map annotation, which in turn can be used to index learnable semantic embedding vectors that encode its meaning. Pre-trained embedding vectors for natural language terms such as algorithms referred to as “BERT” or “GPT3” can be employed. Given a loss function to produce a learning signal, these vectors can be fine-tuned to best suit the application at hand, or trained from scratch. These vectors are then incorporated into V⁰ in place of, or in addition to, the absolute coordinates.

Similar methods can be used to attribute meaning representations to times as well as locations, treating, as an example, calendar data as a map of time, in order to account for days of the week, holidays, and special times of day such as rush hours. Embedding vectors can also be learned for influential factors such as person ID.

In the absence of map data, one algorithm that may be used includes assigning learnable vectors to points on a grid of spatial or temporal locations. This allows points with the same (unknown) annotation to have different embedding vectors, expanding the number of parameters available to the model to an extent that may threaten its generalization ability, although the location vectors still accommodate all the trajectories that pass through them. The parameter count can be reduced by introducing a lexicon of A learned vectors and associating a normalized non-negative weight pₓᵢ, Σᵢ pₓᵢ=1 with each gridded position x. With T positions and lexical embedding dimension D, the parameter count is T(Λ−5)+ΛD, which is less than the TD parameters obtained by placing a vector at each location if T(Λ−5)+ΛD<TD. If T is by far the largest number involved, then this essentially says that the vocabulary size Λ is smaller than the embedding dimension D, which may not be practical.

However, the number of parameters used to map locations to lexical items can be reduced by restricting the weights to the product form pₓₖ_{₁}_{. . . k}_{_{J}}=Πⱼ₌₁^{J}qₓⱼₖ_{ⱼ}, introducing J normalized non-negative weight matrices qₓⱼₖ, Σₖ₌₁^{Λj}qₓⱼₖ=1, and indexing the lexicon from the Πⱼ₌₁^{J}Λⱼ values of (k₁ . . . k_{J}). This results in the potentially more feasible condition Σⱼ₌₁^{J}(Λⱼ−1)<D. With Λⱼ=2 for all j, this is J<D. This may correspond to indexing lexical meanings via J different aspects of meaning.

A training signal for these inputs can be provided by arranging them into a graph structure and applying Graph Neural Network (GNN) methods that train vectors assigned to each graph node to be predictive of fixed features at the node (such as average velocities) and vectors at neighboring nodes. Examples of such GNNs are described in Jie Zhou, Ganqu Cui, Shengding Hu, Zhengyan Zhang, Cheng Yang, Zhiyuan Liu, Lifeng Wang, Changcheng Li, and Maosong Sun. Graph Neural Networks: A Review of Methods and Applications, 2019, the contents of which are hereby incorporated by reference herein.

The graph structure can be based on a discretization of the map, with physically proximate locations assigned to adjacent nodes. Statistical properties of the trajectories passing through each node, along with physical distances and directions to neighboring nodes provide a grounded feature set. Each trajectory can then be converted into a vector sequence V° by reading off the vectors at each node it visits in the graph. Time can be treated similarly, providing vectors representing the meaning of the discretized points in time visited by the trajectory.

It may be helpful to employ a tabular transformer to reduce a potentially large collection of features at the nodes to lower-dimension vectors that capture the most task-relevant information. An example of such a tabular transformer is described in Inkit Padhi, Yair Schi, Igor Melnyk, Mattia Rigotti, Youssef Mroueh, Pierre Dognin, Jerret Ross, Ravi Nair, and Erik Altman. Tabular transformers for modeling multivariate time series. In IEEE ICASSP, 2021, the entire contents of which are incorporated by reference herein.

The GNN training scheme just described can be carried out independently of HFT 130. However, in its information maximization configuration described below, HFT 130 can provide a gradient signal to supplement or replace that from the GNN, thereby training the input to assist the overall task as well as possible.

The input example given here concerns trajectories through a 2-dimensional space, but the algorithm may not restrict on input dimension or application area. The 2-dimensional space may be replaced, for example, by a 3N-dimensional physical configuration space of N particles or a multi-dimensional abstract space of financial indicators.

As further shown in the example of FIG. 1, HFT 130 includes memory clustering 136, and anomaly detection 138. Anomaly detection 138 operations may occur mainly on this fully encoded embedding space (which also contains the embeddings for the shorter, less abstract segments) using a memory clustering method 136 that potentially avoids confusing rare but normal trajectories with anomalous ones by normalizing for relevant side information. Any auxiliary information 141 (“AUX 141”) such as a Person identifier (“ID”) or trajectory objective is ingested by both decoder 134 and anomaly detector 138, thereby possibly improving results.

HFT 130 is structured, as noted above, as a variational auto-encoder (VAE) 506 with a decoder 134 that approximately reproduces the input vectorized trajectory for use in the training process of HFT 130 and the sequence generation process.

A modified IRL module 126 generates a physical sequence from the vectorized sequence, respecting the imposed objective 129 while matching trajectory 121 as closely to the background as possible. IRL 126 may employ feedback (not shown) between the sequence generator of encoder 132 and anomaly detector 138.

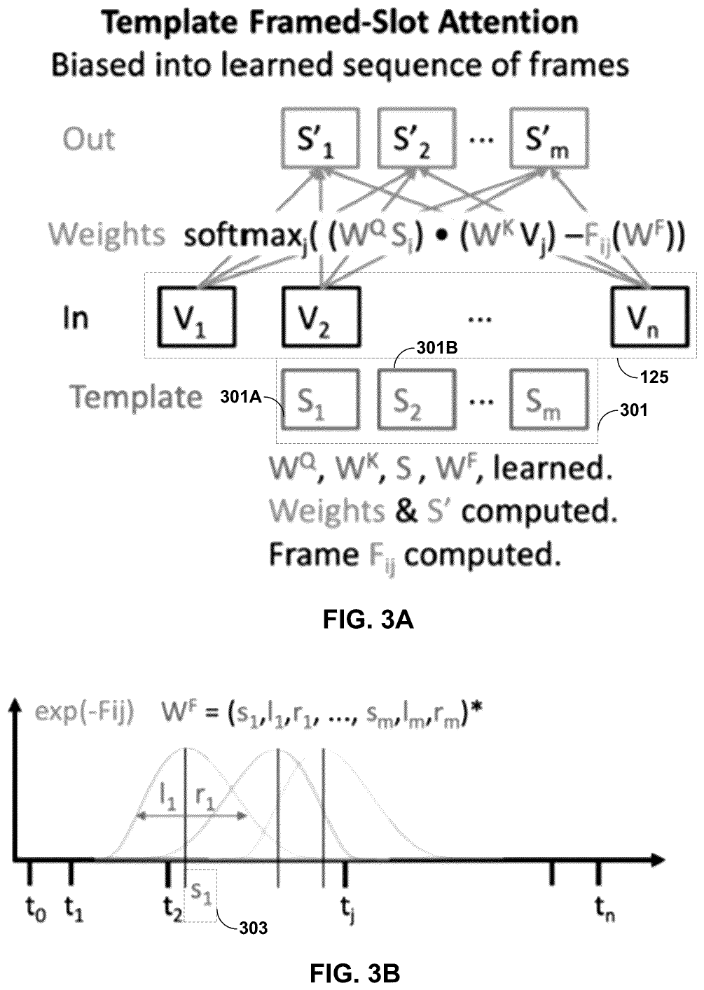

The hierarchical segmentation is learned by HFT 130. HFT 130 includes framing transformer encoder 132, the trajectory or segment embedding space, and decoder 134. A transformer is a feed forward neural network architecture that uses a learned attention mechanism (discussed in more detail below with respect to FIGS. 3A and 3B) to transform one sequence into another, usually in several stages. In HFT 130, an initial sequence of stages forms encoder 132 that maps the sequence of vectors 125 into a single embedding vector shown as S 133. This semantic embedding vector S 133, which encodes task-relevant information from sequence 131, is then passed to a decoder 134 that produces a desired target sequence of reconstructed input vectors (denoted V′) 135A-135N (“V′ 135,” which may also be referred to as sequence 135) through a succession of stages roughly mirroring those of encoder 132. By setting the target equal to the input, HFT 130 is made into an auto-encoder, an unsupervised learner for vector encodings of the input sequences 131. HFT 130 learns to expose the hierarchical structure of sequences 131 along with the implicit hierarchical ontology of qualitative meanings associated with the segments.

There may be no natural distinction between full trajectories 121 and segments 131, as both trajectories 121 and segments 131 all share the same embedding space. This way, diverse but otherwise unremarkable ways to carry out an activity may become represented by similar vectors. In addition to providing a compact encoding of the sequence data, the fixed-dimension embedding vectors may be much easier to work with than the variable-length sequences. These fixed-dimension embedding vectors S 133 may represent the principal inputs to anomaly detection 138.

HFT 130 is, in the example of FIG. 1, structured as a variational auto-encoder (VAE). Rather than produce embedding vectors directly, the VAE encoder outputs parameters defining a probability distribution over the embedding space. Samples from this distribution are then fed to the decoder 134, using simple algebraic algorithms to preserve differentiability through the sampler so that training can proceed as usual. In some aspects, this algebraic device may be replaced with an information-maximization technique that may produce more efficient encodings. The noise introduced in this way brings robustness to the embedding space so that small changes in the input sequence usually result in small encoding changes, and generally improves the interpretability of the embeddings. The randomness also assists the search for ways to generate non-anomalous trajectories that satisfy imposed objectives.

In some instances, an approach to anomaly detection has three stages. Memory clustering 136 organizes the trajectory embedding space into classes and estimates the probability of any given semantic-level trajectory or segment given its class, thereby potentially avoiding the simplistic tendency to judge rare but normal trajectories to be anomalous. IRL 126 may assess whether the physical trajectory or segment is interpretable as a path planned with commonplace objectives. A suite of trajectory-oriented statistical tests may be applied. In some aspects, these tests are best applied in sequence, however, other more complex conditionally weighted configurations may be used.

Next, IRL 126 will be discussed. In ordinary Reinforcement Learning (RL), a policy is learned for generating trajectories that maximize integrals along the trajectory of a discounted reward, in the form of a function defined over the space through which the trajectories travel. In Inverse RL (IRL), HFT 130 is given samples from a distribution over trajectories, and co-learns a reward function and a policy that drive RL to generate trajectories from the given trajectory-level distribution. So, the reward function for the activity “be at a grocery store” may be maximal at grocery stores, and gradually decrease as one moves away from a store along a plausible route. The example trajectories (and trajectory segments) are obtained by tracking input trajectories 121 and segments 131 through the multi-resolution graph and encoder 132, tracing the segmentation defined by the framing at each encoder level back to the original physical coordinates.

IRL 126 generates a trajectory 127 influenced by semantic guidance provided by decoder 134. HFT 130 may operate at the semantic level, describing the variety of ways that complex activities can be constructed from simpler activities. At the base of this hierarchy are single events. These events are semantic types, as opposed to physical instances. For example, such an event might have the interpretation “Be at a grocery store on a Tuesday morning”, as opposed to “Be at the Safeway at 4th and Main at 9:00 on Tuesday, June 7.” The event vectors can be directly compared to vectors indexed from the MRG in the space-time region of interest to find plausible locations and times for each event vector, of which there may be many. Given an objective function 129 to determine preferences, a dynamic programming or similar algorithm can be used to decide which instances to visit, in which order. The objective function is supplied by the using the IRL 532 module to paint a reward function over the space-time region of interest. As a function of the semantic annotation in the space-time region of interest, this reward accounts for transient phenomena such as storms and the shifting densities and velocities of the ambient trajectories as the reward guides the way to producing as unremarkable a trajectory 127 as possible at the physical level.

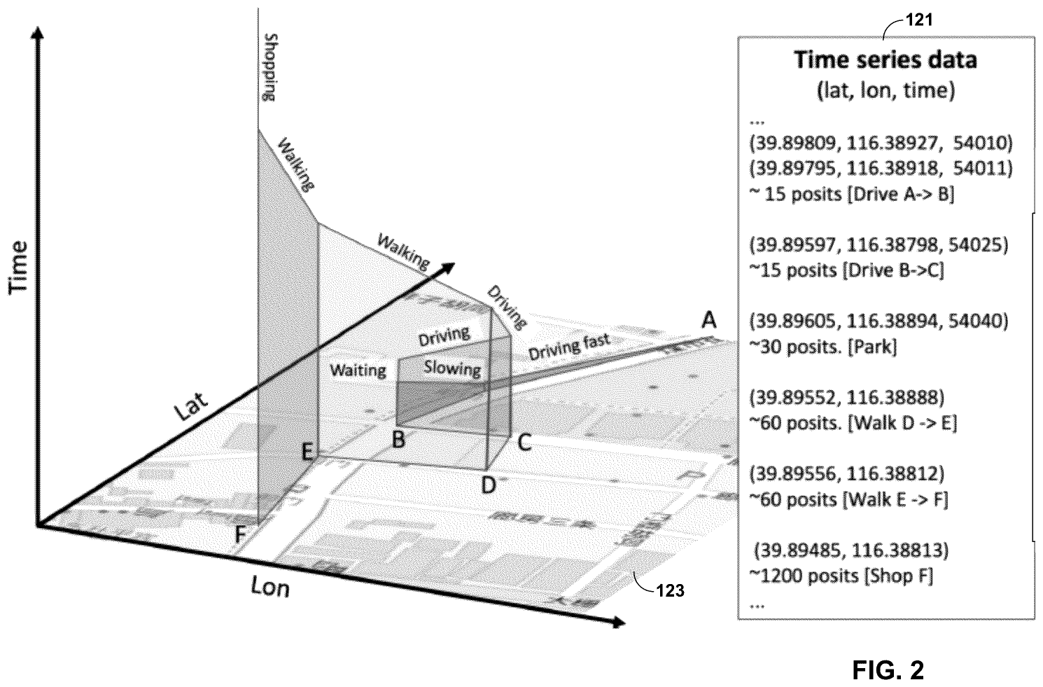

FIG. 2 is a conceptual diagram illustrating an example trajectory segmentation performed by the hierarchical framing transformer of FIG. 1, in accordance with one or more techniques of the disclosure. As described above, HFT 130 (FIG. 1) divides trajectories 121 into meaningful segments 131 such as those illustrated in FIG. 2, and assigns an embedding vector to represent the meaning for each respective one of segments 131. The sequence 131 is thereby converted into a shorter sequence of vectors that represent more abstract activities. HFT 130 includes a transformer attention mechanism, modified as described below with respect to FIGS. 3A and 3B, configured to define segments 131. This process is applied hierarchically, eventually producing a single semantic embedding vector 133 representing sequence 131 in its entirety. These layers of the transformer represent encoder 132.

The time series 121 is divided into consecutive contiguous segments 131. HFT 130 is configured to assign a semantic embedding vector to each segment 131. Though not shown in the example of FIG. 2, this can be continued hierarchically. For example, segments A→B, B→C and C→D can be considered to form a single more abstract activity, driving to a shopping area, while D→E and E→F constitute walking to a shop, and the stay at F constitutes shopping. In this last case, the same single segment stands at two levels of the hierarchy. HFT 130 may support this pass-through possibility in order to accommodate trajectories 121 of widely varying complexities in a single model.

Encoder 132 is followed by decoder 134 that hierarchically reproduces input vector sequences 125 (which is another way to refer to input vectors V 125), forming an auto-encoder. The model is, in this example, trained with a loss function that measures how well each sequence 131 generated by decoder 134 matches the input vectors V 125 to encoder 132. Each encoder layer may produce an output of a specific length, regardless of the length of the input sequence to encoder 132. When training, the corresponding decoder layer may be constrained to produce a sequence of the same length so that the output of the final decoder layer is trivially alignable with V°.

Each encoder layer has the same overall structure, and likewise for the decoder layers, but these two structures differ somewhat in order to handle the fact that encoder 132 reduces sequence length while decoder 134 lengthens sequences. In some examples, the generic encoder layer has three variants: deterministic, variational and information-driven variational. In some examples, there is one generic decoder layer architecture, variational. Information-driven variational encoder 132 can be trained by an information maximization principle potentially without using decoder 134 to form an auto-encoder.

A standard transformer typically converts one vector sequence of a given length into another of the same length. This is done in several length-preserving stages of a layered architecture. Each layer uses an attention mechanism to determine how much influence each step in the layer's input sequence will have on each step of its output sequence.

Rather than transform a sequence in a length-preserving way, HFT 130 may partition sequence of vectors V 125 into meaningful segments 131 (shown as segments A→B, B→C, C→D, D→E, and E→F in the example of FIG. 2) and assign a meaningful semantic embedding vector to each respective one of segments 131. Thus, each layer produces a shorter sequence than was presented to its input. A modification of the transformer attention mechanism is used to learn how to perform the division into segments, which is described in more detail with respect to FIGS. 3A and 3B below.

FIGS. 3A and 3B are conceptual diagrams illustrating example modifications made to a standard transformer attention mechanism for a Hierarchical Framing Transformer (HFT), in accordance with one or more techniques of the disclosure. A standard transformer attention mechanism may be modified such that for each head (which may also be referred to as an “attention head” or as a “template”), the input sequence 125 (which is another way to refer to V 125 shown in the example of FIG. 1) is mapped into slots Sᵢ′ of a template (FIG. 3A) while approximately preserving the sequence order i (shown in FIG. 3B).

The standard mechanism multiplies learned linear transformation matrices W^{Q} and W^{K} to each input vector Vᵢ to form a query vector W^{Q}Vᵢ and a key vector W^{Q}Vᵢ. The n² dot products (W^{Q}Vᵢ)·(W^{Q}Vᵢ) are then formed to compare each input, as a query, to each input as a key. Then a softmax operation (softmaxⱼ(x₁, . . . , xₙ)=e^{x}ⱼ/Σᵢe^{x}^{ᵢ}) produces weights wᵢⱼ=softmaxj((W^{Q}Vᵢ)·(W^{Q}Vᵢ)) that are normalized over the keys for each query. Each output is then set to a weighted sum of the inputs: Vᵢ′=ΣᵢⱼwᵢⱼVⱼᵢ. This attention component learns key and query transformations that result in the optimal combination of inputs for each output for the task at hand.

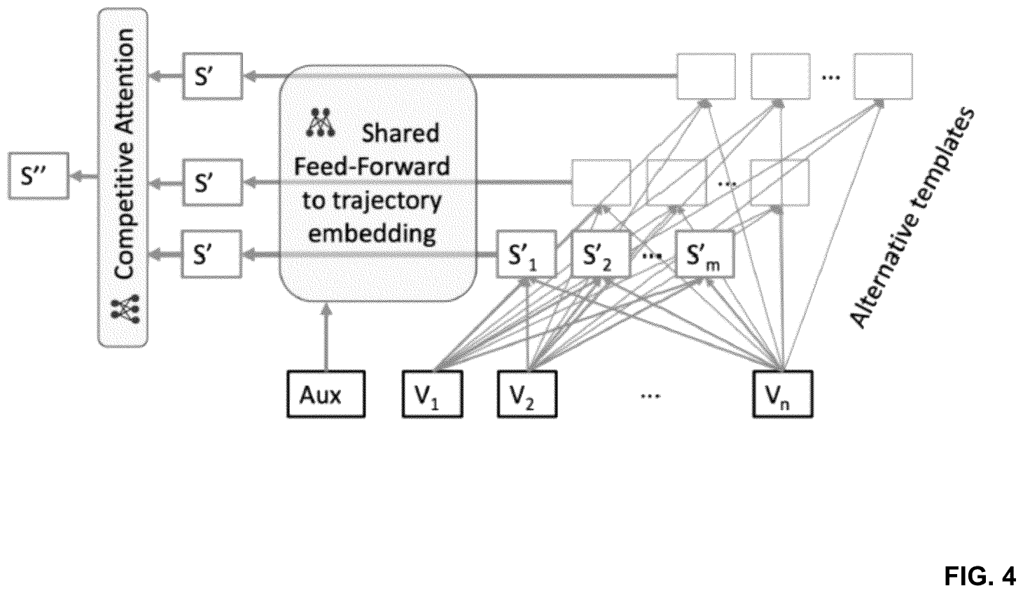

This standard attention mechanism may be unsuitable for two reasons. First, the standard attention mechanism may not shorten the sequence. More importantly, the standard attention mechanism may be insensitive to the order of its inputs (as a result of coming from the context of NLP as described above). The first reason may be solved by requiring the desired number of outputs T′. The standard multi-headed architecture is used to allow HFT 130 to choose from an ensemble of output lengths, as illustrated with respect to FIG. 4, which shows a multiheaded generalization of the HFT attention mechanism of FIG. 3A, in accordance with one or more techniques of the disclosure and which also shows the feedforward layer that follows, with its ability to accept any auxiliary information that may be available in addition to the attention output. One possible difficulty is that such modification ceases to make sense to form query vectors, one per output, by transforming the T>T′ input vectors. This possible difficult may be handled by introducing a learned slot vector Sᵢ 301 for each output and defining the query vector for each slot i as W^{Q}Sᵢ. The collection of slots in each head may be referred to as a template. Slot vectors 301 are part of the template; they do not vary with input vectors 125. Such slot vectors 301 can be shared between templates to implement a single type of episode playing a role in multiple activities.

The attention is modified with multiplicative envelopes as illustrated in the example of FIG. 3B in order to force consecutive slots to focus attention on consecutive segments of input vectors 125. For example, the first slot S₁ 301A (FIG. 3A) has an envelope centered at time s₁ 303, and mostly decays away after time l₁ in the past and time r₁ in the future. The envelope for S₂ 301B (FIG. 3A) picks up as the S₁ envelope decays toward its future, and so forth for the remaining slots. The envelopes are implemented as a non-negative term Fᵢⱼ subtracted from the argument to the softmax. This term is minimal when input step j is near the center of the segment attributed to slot i, and increases rapidly outside the slot.

One example way to construct such envelopes is as follows. Let lᵢ and rᵢ be freely variable width parameters for a suitable family of functions, such as Gaussians (in which case lᵢ=rᵢ). HFT 130 sets the peak parameters sᵢ variable only within the ordering constraint s₁<s₂< . . . <s_{T}. One possible way to achieve this is to define s₀=0, s₁=a₁ and for i>5, sᵢ=aᵢ+(1−aᵢ)sᵢ₋₁/Σⱼ₌₁ⁱ⁻¹aⱼ, where the aᵢ form a learned partition of unity (such as softmax output). This may provide an ordered partition of unity that can be re-scaled to yield the desired (sᵢ, . . . , s_{T}).

While the above framing mechanism may be adequate, the above framing mechanism may suffer from two undesirable properties. First, the above framing mechanism is recursive with depth T′, the number of slots. Gradients may be propagated through this recursion. However, this property is not a major problem if m is small. The second property is that the partition of unity a may be obtained through an optimization procedure for every forward pass of every input sequence. These parameters are not part of the model. It would possibly be better if the model contained a feed-forward process that played a similar role.

Such improvements can be obtained through a three-component process that will now be described. The central component is a parameterized family of time warps T, each of which monotonically maps the interval [0, 5] onto itself. With re-scaling, this is used to map the T−5 unit time intervals within the T input sequence steps (1, 2, . . . , T) into the unit interval; specifically, step i is scaled to

$$ξ i = ( i - 5 ) / ( T - 5 ) \qquad ( 1 )$$

and then mapped to τ(ξi; θ), where θ is the (generally multivariate) parameter specifying the transformation. This warped time value is then passed to a soft analog-to-digital converter component x that maps it to the value Fᵢⱼ that, as in the first scheme considered, modifies the softmax in FIG. 3A to focus attention on the steps j of the input segment attributed to slot i. The time-warping having been accomplished already, the soft analog-to-digital converter simply (and softly) assigns identically sized consecutive intervals within the unit interval to each slot. The remaining component is a learned mapping from the entire input sequence to the time-warp parameters θ.

Next, for concreteness, suitable example architectures for these three components will be described. Let the time-warp τ be defined by

$$τ ( ξ ; r , μ ) = \frac{1}{l} {\sum }_{i = 1}^{l} \frac{( 1 + {e}^{{r}_{i} ( 1 - {μ}_{i} )} ( 1 + {e}^{- {r}_{i} {μ}_{i}} )}{{e}^{- {r}_{i} {μ}_{i}} ( {e}^{{r}_{i}} - 1 )} [ \frac{{e}^{{r}_{i} ( ξ - {μ}_{i} )}}{1 + {e}^{{r}_{i} ( ξ - {μ}_{i} )}} - \frac{{e}^{- {r}_{i} {μ}_{i} )}}{1 + {e}^{- {r}_{i} {μ}_{i}}} ] \qquad ( 2 )$$

where the multi-variate parameter θ is the collection of 2l scalars θ=(r, μ)=(r₁, μ₁, . . . , r₁, μ₁). This expression is simply a sum of l sigmoids, truncated and rescaled so that each varies from 0 to 5/l as varies from 0 to 5, so that τ varies monotonically from 0 to 5. The μ parameters indicate the uniformly unit-scaled times ξ at which the warped time can be regarded as stepping up to the next sigmoid, and the r parameters specify the rapidity of the step. These steps can, but need not and generally will not, correspond to the template slots; they simply provide an expressive and interpretable family of monotonic maps from the unit interval onto itself. The point of the approach is to disentangle sequentiality from slot assignment.

For a soft analog-to-digital converter for s slots, choose T′ nominal slot centers in the unit interval at

$${s}_{i} = \frac{1}{2 s} + \frac{1 - 1 / s}{s - 1} ( i - 1 ) \qquad ( 3 )$$

for i in 5, . . . , s. The attention envelope terms can be defined as

$${F}_{ij} = {α ( {s}_{i} - τ ( {ξ}_{j} ; r , μ ) )}^{2} \qquad ( 4 )$$

where α>0 governs the strength of the focusing.

There are numerous options for defining the learnable mapping from the input sequence to the parameters θ. One is to use the template architecture of FIG. 3A without the Fᵢⱼ term, a single slot, and follow with a feedforward network (as is usual in transformer architectures) to obtain θ. This can also be generalized to a multi-headed architecture in the usual way.

An encoder, such as encoder 132 shown in the example of FIG. 1, formed by stacking the layers described above (along with feedforward and/or normalization layers) envisages taking an entire sequence as input vectors 125 and converting this sequences to progressively shortened sequences of vectors 131 representing increasingly abstract activities until as single vector 133 remains. One possible drawback to this approach is that a potentially large and variable number of slots may be required in the lowest layer templates 301. Furthermore, it can reasonably be expected for many types of simple activities to be repeated within the input sequence, in which case it would possibly be best to use the same subsequence of slot vectors for each repetition.

To address this issue, HFT 130 may be broken into a progressively applied ensemble of HFTs 130, each pairing a single encoder layer to its corresponding decoder layer. For each application, HFTs 130 may break input vectors 125 into a set of short sequences using fixed length overlapping sliding windows. This way, templates 301 need only have enough slots to capture activities that may take place during the windowed time at the abstraction level involved. After training one abstraction level, the model is scanned across the entire input sequence to produce the shorter, more abstract sequence to present to the next level.

This leaves a question of how to splice the outputs at window overlaps. One possible approach is simply to average the framing components Fᵢⱼ at overlapping time steps. Mathematically, let F′ be computed from the frame following that from which F is computed, and let the frame length be L and the overlap be a, so that the within-frame input coordinates of F and F′ are aligned as shown in formula (5) below in the overlap region.

$$\begin{matrix}End of F : & \cdot & \cdot & L - a + 1 … & L \cdot & \cdot \\ Beginning of F ' : & \cdot & \cdot & 5 … & a \cdot & \cdot \end{matrix} \qquad ( 5 )$$

Then with F̅_{ι}=(F_{i(L-a+j′)}+F_{ij′}′)/2 for j′ in (1, . . . , a), F̅_{ι} may be redefined as =F_{i(L-a+j′)}=F_{ij′}′=F̅_{ij′}, and follow through with the remaining transformer computation to obtain a consistent output sequence.

Breaking the hierarchy into steps in this way may provide the advantage of facilitating training by reducing the depth of the network. However, breaking the hierarchy into steps may present the disadvantage in that information from higher abstraction levels is made unavailable to the lower levels. This disadvantage may be ameliorated to some extent by splitting the hierarchy into successions of a few layers instead of one layer at a time. Another approach would be to adapt a pyramid approach used in computer vision architectures to move information from higher to lower layers.

Described in the example above is a deterministic encoder layer, for which each slot of the output sequence is a deterministic function of the input sequence. An alternative example to outputting each slot vector directly is to output parameters of a family of probability distributions over such vectors, and sample vectors from that distribution. Coupled with a decoder that also takes this approach and training the overall model as an auto-encoder can result in a variational auto-encoder (VAE). This approach tends to produce simple distributions over the latent space, perhaps because simple distribution families are used (usually Gaussians).

The fact that a VAE produces its output by sampling from a distribution presents the gradient-based training with the challenge of differentiating through the sampling. This is normally handled by a re-parameterization process, which removes the noise generation from the differentiation path, at least for Gaussians. To sample from a Gaussian N(μ, σ) with mean vector μ and covariance matrix σ, one draws a sample from a standard Gaussian N(0,I) (where 0 is the zero vector and I the identity matrix) and forms the vector x=μ+σ^{1/2}ξ which is differentiable with respect to the distribution parameters μ and σ, and is also a sample from N(μ, σ), as can be seen by writing (\tilde{x}−\tilde{μ})σ⁻¹(x−μ) as \tilde{ξ}Iξ.

A possible alternative to using the reparameterization process is to train encoder 132 on an information maximization objective. This is an alternative to auto-encoding that eliminates the need to use (and train) decoder 134. One maximizes the mutual information between the input x and output p of the probabilistic transformation p(ϕ|x), or rather an approximation (6) to the mutual information computed from a data set containing U samples of the input.

$${I}_{ϕ X} = {\int }_{X} dx {\int }_{Φ} d ϕ p ( ϕ \vert x ) log \frac{p ( ϕ \vert x )}{p ( ϕ )} \approx \frac{1}{U} {\sum }_{u} {\int }_{Φ} d ϕ p ( ϕ \vert {x}^{u} ) log \frac{p ( ϕ \vert {x}^{u} )}{p ( ϕ )} = {H}_{Φ} - 〈 {H}_{Φ \vert X} 〉 \qquad ( 6 )$$

$$p ( ϕ ) = {\int }_{X} dxp ( ϕ \vert x ) p ( x ) \approx \frac{1}{U} {\sum }_{u} p ( ϕ \vert {x}^{u} ) \qquad ( 7 )$$

$$〈 {H}_{Φ \vert X} 〉 = - \frac{1}{U} {\sum }_{u} {\int }_{Φ} d ϕ p ( ϕ \vert {x}^{u} ) log p ( ϕ \vert {x}^{u} ) \qquad ( 8 )$$

$${H}_{Φ} = - {\int }_{Φ} d ϕ p ( ϕ ) log p ( ϕ ) \qquad ( 9 )$$

Expression (6) expresses a tradeoff between maximizing the variety of feature values, as measured by the feature entropy H_{Φ} in formula (9), and the specificity of the features associated with each input, as measured by [symbol] H_{Φ|}X [symbol] in formula (8).

If p(φ|x) is modeled as a Gaussian p(φ|x; μ, σ) with parameters μ and σ given by the feedforward network that post-processes attention output, then at the integral over Φ in [symbol] H_{Φ}|X [symbol] in formula (8) may be obtained analytically. The same cannot be said for H(in formula (9), due to the sum (7) within the logarithm, but there are several ways to approximate this integral. One way is to apply variational inequalities such as the Evidence Lower Bound (ELBO), although this involves solving an optimization problem that scales with the size U of the dataset. A typically less tight bound that avoids this issue follows from Jensen's inequality:

$$- log p ( φ ) \geq \frac{1}{U} {\sum }_{u} log ( p ( φ \vert xu ) .$$

Another approach uses a Taylor expansion of the logarithm, and yet another uses the replica method.

Each decoder layer is paired with a corresponding encoder layer, and learns to invert the encoding to the greatest feasible extent. The encoding is a lossy operation, reducing segments of various lengths to single slots of a template, so there is no unique inverse for any given slot vector. Therefore, a stochastic approach is taken that is in some respects similar to that taken by the VAE version of encoder 132, but with modifications to generate sequences of a variety of lengths.

Decoder 134 may perform a decoding process that begins by defining a distribution from which to select the sequence length Tin formula (1). During training, this is unnecessary because the same T value as was present in the corresponding encoder input is used so that the final encoder output can be directly aligned with the input, enabling a simple definition for the auto-encoding cost function (such as Σₜᵢ(vₜᵢ′−vₜᵢ)² where vₜᵢ (respectively vₜᵢ′) is component i of the input (respectively output) vector at step t). Otherwise, T is chosen from a learned distribution over allowed sequence lengths (1, . . . , Tₘₐₓ). This distribution can be specified by a neural network model mapping the slot vectors of the template to a partition of unity, using a softmax output layer containing Tₘₐₓ nodes. For more smoothly varying results, one might instead output parameters of a distribution such as the Beta, or a mixture of Betas, which has support restricted to the unit interval, and rescale appropriately. This model is trained on the sequences and slot vectors produced at the relevant encoder layer.

Having selected a length T, HFT 130 can form the non-warped time points using formula (1) and the envelope terms Fᵢⱼ from formula (4), using the r and μ parameters of encoder 130. (In training, the r and μ parameters are tied between the encoder and decoder.) Applying a softmax over the slots i then produces a partition of unity pᵢⱼ ascribing influence over each step j from each slot i.

Decoder 134 may next generate the output vector sequences, V=(v₁, . . . , V_{T}) (where the vᵢ are input vectors or segment vectors depending on the abstraction level of the encoder-decoder pair) from the slot vector sequences S=(s1, . . . , s_{T}′). The overall approach is to sample from a Gaussian process over sequences of length T that is a learned function of S. More explicitly, a feedforward network produces a length-T vector μ(S) and a T x T inverse covariance matrix β(S) (the precision matrix) as a learned function of the slots S. In some aspects, a Gaussian process is used rather than independent sampling at each time point (which amounts to a diagonal Gaussian process) in order to be able to express correlations in the time series.

In some examples, the precision matrix β is symmetric and positive. Providing these properties for the precision matrix can be enabled by parameterizing the precision matrix as a Cholesky decomposition β=L\tilde{L} where L is a lower-triangular matrix with manifestly positive diagonal elements. This can be arranged by writing the diagonal elements as squares, or more elaborate formulas (such as rescaled sigmoids) that restrict their range of variation.

A component of a vector time series carries two indices, one for time and one for the vector dimension. Thus, μ(S) has components μₜᵢ and L(S) has components L_{tt′ii′}. However, it is expected that strong correlations between nearby times, but not between nearby vector indices, the order of which has no significance. As such, it can be assumed that L has the form L_{tt′ii′}=δ_{ii′}L_{tt′}, where δ_{ii′}=1 for i=i′ and is zero otherwise.

In some example, the time series V may exhibit local correlations, which can be arranged by setting the elements of (two-index) β that lie far from the diagonal to zero. Setting such elements of (two-index) L to zero will accomplish this.

Using the partition of unity p, one can structure μ(S) and L(S) to reflect the greater or lesser influence of different slots on different time intervals. One example way to do this is to take μ to have the form

$${μ}_{ti} ( S ) = {\sum }_{k} {p}_{kt} {f}_{i} ( {s}_{k} ) \qquad ( 10 )$$

and similarly for L, where f is a feedforward network. Alternatively, one can enable the network to take account of neighboring slots by taking the form

$${μ}_{ti} ( S ) = {f}_{i} ( {\sum }_{k} {p}_{kt} {s}_{k} ) \qquad ( 11 )$$

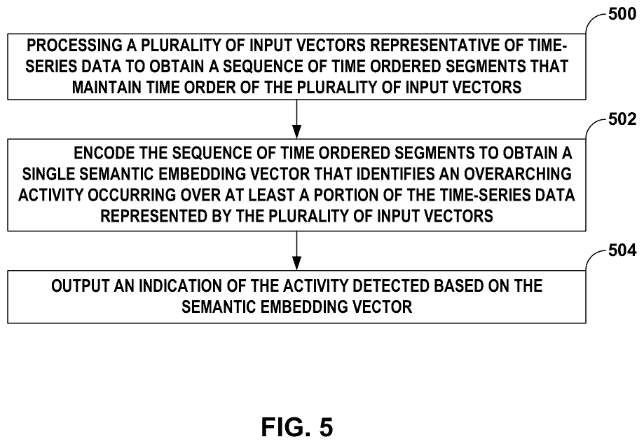

FIG. 5 is a flowchart illustrating example operation of the computing system of FIG. 1 in applying a hierarchical framing transformer for activity detection in accordance with various aspects of the techniques described in this disclosure. As described above, encoder 132 may first process the plurality of input vectors 125 to obtain a sequence of time ordered segments 131 that maintain time order of the plurality of input vectors 125 (500). Encoder 132 may next encode the sequence of time ordered segments 131 to obtain a single semantic embedding vector 133 that identifies an overarching activity occurring over at least a portion of the time-series data 121 represented by the plurality of input vectors 125 (502). Encoder 132 may output an indication of the activity detected based on semantic embedding vector 133 (504), which may be used in a wide number of different contexts, such as anomaly detection for pattern of life analysis, insurance driving analysis, financial fraud detection, network troubleshooting, network intrusion detections, etc.

An example application that incorporates the techniques described herein, referred to as CATNMOUSE (Clustered Abstract Trajectories that Normalize Measures of Ordinary and Unusual Semantic Embeddings), addresses the challenges of complexity and scale in human trajectory data by reducing it to the semantic abstraction level at which patterns of life either play out systematically or expose themselves as anomalous. The techniques of the example application disclosed herein scan allow intelligence community (IC) organizations to better protect movements of their own agents, optimize collection to Find, Fix, Track (FFT) adversaries, and solve a variety of other IC unique problems.

CATNMOUSE is designed to (1) promote physical trajectories into a semantic space where their anomalousness can be most clearly assessed and (2) generate physical sequences that make unremarkable semantic sense as well as possible when constrained by an imposed objective.

To this end, the Hierarchical Framing Transformer (HFT) discussed above can perform the segmentation and associate the discovered segments with semantic embedding vectors that encode their meanings. These vectors are designed to have little sensitivity to semantically inconsequential details such as segment endpoints (e.g., parking vs. getting out of the car). At higher abstraction levels, they are unaffected by minor qualitative variants such as unsurprising side trips (e.g., stopping for gas), but not by potentially consequential ones such as highly circuitous routes.

To adjust for explanatory side information such as person ID or stated objectives, the HFT learns embedding vectors that characterize such explanatory factors, enabling generalization across, for example, people with similar lifestyles. The techniques described herein discover these factors using a memory clustering technology, which underpins the first stage of a three-stage anomaly detection system with a means to assess the probability of a trajectory given its most explanatory factors. This is followed by a modified inverse reinforcement learning (IRL) module that detects unusual objectives, and a suite of statistical tests including one based on Gram matrices. A human mobility subject matter expert (SME) can sample and study the unsupervised artifacts to ensure that the algorithms operate sensibly.

CATNMOUSE overcomes incomplete, obsolete, or non-existent geospatial foundation data with statistical analysis of trajectory data, using features such as velocities and dwell times to reveal numerous types of transportation corridors and destinations. This unlabeled map is integrated with any available geospatial data using a semantic enrichment module that applies graph neural network (GNN) methods to produce semantic embedding vectors suitable for input to the HFT. The vectors are indexed by the nodes of a multi-resolution graph (MRG) that covers busy regions densely and quiet regions sparsely. The time period of interest is handled similarly. Semantically similar locations (shopping malls) and times (Friday nights) acquire metrically similar vectors.

HFT is designed to meet not only the anomaly detection challenges, but also the challenge of generating near-normal trajectories that satisfy imposed objectives. It is structured as a variational auto-encoder (VAE) that generates sequences in addition to encoding them. These sequences of semantic activities (e.g., drive to a mall, park) guide a further modified IRL method to generate a physical sequence that meets the imposed constraints and accounts for transient environmental conditions such as storms or traffic jams. The physical trajectories are then assessed by the anomaly detector in an adversarial training process.

The techniques described herein may easily be generalized to detect and generate anomalous coordinated activities. For n group members, one simply generalizes the notion of trajectory from 2 dimensions to 2n dimensions, which remains computationally feasible for modest values of n. The challenge is to discover the existence of the groups and their members in a computationally feasible way. For this, in some aspects, CATNMOUSE uses the PointConv algorithm, that efficiently trims millions of trajectories down to a shortlist of those likely to be involved in coordinated activities, based on the greater compressibility that coordination entails. These reduced sets then seed transformer-based social graph construction methods that identify likely groups and their objectives, aided by SME-guided heuristics such as trajectory endpoint classification.

In this way, various aspects of the techniques may enable the following examples.

Example 1. A computing system configured to perform activity detection, the computing system comprising: a memory configured to store a plurality of input vectors representative of time-series data; processing circuitry coupled to the memory, and configured to implement an unsupervised machine learning transformer, wherein the unsupervised machine learning transformer is configured to: process the plurality of input vectors to obtain a sequence of time ordered segments that maintain a time order of the plurality of input vectors; encode the sequence of time ordered segments to obtain a single semantic embedding vector that identifies an activity occurring over at least a portion of the time-series data represented by the plurality of input vectors; and output an indication of the activity detected based on the semantic embedding vector.

Example 2. The computing system of example 1, wherein the unsupervised machine learning transformer includes a hierarchical framing transformer, and wherein the hierarchical framing transformer includes a feed forward neural network having multiple attention heads, wherein the feed forward neural network is trained via unsupervised learning.

Example 3. The computing system of example 2, wherein the feed forward neural network includes multiple layers, each of the multiple layers generating a separate sub-semantic embedding vector for each of the sequence of time ordered segments that identifies a sub-activity performed during the overarching activity.

Example 4. The computing system of any of example 1-3, wherein the unsupervised machine learning transformer includes an unsupervised machine learning model that acts as a decoder and is configured to decode the semantic embedding vector to reconstruct the plurality of input vectors and obtain a plurality of reconstructed input vectors, and wherein the unsupervised machine learning transformer performs unsupervised learning, based on the plurality of reconstructed input vectors and the plurality of input vectors, to adjust one or more weights applied to a plurality of subsequent input vectors when obtaining a subsequent single semantic embedding vector.

Example 5. The computing system of any of examples 1-4, wherein the unsupervised machine learning transformer implements a variational auto encoder.

Example 6. The computing system of any of examples 1-5, wherein the processing circuitry is further configured to perform preprocessing of the time-series data to condition the time-series data during generation of the plurality of input vectors.

Example 7. The computing system of any of examples 1-6, wherein the processing circuitry is further configured to perform semantic enrichment with respect to the time-series data to condition the time-series data during generation of the plurality of input vectors.

Example 8. The computing system of any of examples 1-5, wherein the processing circuitry is further configured to: perform preprocessing of the time-series data to condition the time-series data to obtain a plurality of preprocessed embedded vectors; and perform semantic enrichment with respect to the plurality of preprocessed embedded vectors to generate the plurality of input vectors.

Example 9. The computing system of any of examples 1-8, wherein the processing circuitry is configured to: perform activity detection with respect to the single semantic embedding vector to identify the activity; and output an indication of the activity.

Example 10. The computing system of example 9, wherein the activity detection includes anomaly detection with respect to the single semantic embedding vector.

Example 11. A method of performing activity detection, the method comprising: processing, by an unsupervised machine learning transformer executed by a computing system, a plurality of input vectors representative of time-series data to obtain a sequence of time ordered segments that maintain time order of the plurality of input vectors; encoding, by the unsupervised machine learning transformer, the sequence of time ordered segments to obtain a single semantic embedding vector that identifies an overarching activity occurring over at least a portion of the time-series data represented by the plurality of input vectors; and outputting, by the unsupervised machine learning transformer, an indication of an activity detected based on the semantic embedding vector.

Example 12. The method of example 11, wherein the unsupervised machine learning transformer includes a hierarchical framing transformer, and wherein the hierarchical framing transformer includes a feed forward neural network having multiple attention heads, wherein the feed forward neural network is trained via unsupervised learning.

Example 13. The method of example 12, wherein the feed forward neural network includes multiple layers, each of the multiple layers generating a separate sub-semantic embedding vector for each of the sequence of time ordered segments that identifies a sub-activity performed during the overarching activity.

Example 14. The method of any of examples 11-13, wherein the unsupervised machine learning transformer includes an unsupervised machine learning model that acts as a decoder and is configured to decode the semantic embedding vector to reconstruct the plurality of input vectors and obtain a plurality of reconstructed input vectors, and wherein the unsupervised machine learning transformer performs unsupervised learning, based on the plurality of reconstructed input vectors and the plurality of input vectors, to adjust one or more weights applied to a plurality of subsequent input vectors when obtaining a subsequent single semantic embedding vector.

Example 15. The method of any of examples 11-14, wherein the unsupervised machine learning transformer implements a variational auto encoder.

Example 16. The method of any of examples 11-15, further comprising performing preprocessing of the time-series data to condition the time-series data during generation of the plurality of input vectors.

Example 17. The method of any of examples 11-16, further comprising performing semantic enrichment with respect to the time-series data to condition the time-series data during generation of the plurality of input vectors.

Example 18. The method of any of examples 11-15, further comprising: performing preprocessing of the time-series data to condition the time-series data to obtain a plurality of preprocessed embedded vectors; and performing semantic enrichment with respect to the plurality of preprocessed embedded vectors to generate the plurality of input vectors.

Example 19. The method of any of examples 11-18, further comprising: performing activity detection with respect to the single semantic embedding vector to identify the activity; and outputting an indication of the activity.

Example 20. A non-transitory computer-readable storage medium having instructions stored thereon that, when executed, cause one or more processors to: invoke an unsupervised machine learning transformer that: processes a plurality of input vectors representative of time-series data to obtain a sequence of time ordered segments that maintain time order of the plurality of input vectors; encodes the sequence of time ordered segments to obtain a single semantic embedding vector that identifies an overarching activity occurring over at least a portion of the time-series data represented by the plurality of input vectors; and outputs the semantic embedding vector.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system configured to perform activity detection, the computing system comprising:
a memory configured to store a plurality of input vectors representative of time-series data;
processing circuitry coupled to the memory, and configured to implement an unsupervised machine learning transformer, wherein the unsupervised machine learning transformer is configured to:
process the plurality of input vectors to obtain a sequence of time ordered segments that maintain a time order of the plurality of input vectors;
encode the sequence of time ordered segments to obtain a single semantic embedding vector that identifies an activity occurring over at least a portion of the time-series data represented by the plurality of input vectors; and
output an indication of the activity detected based on the semantic embedding vector.

2. The computing system of claim 1,
wherein the unsupervised machine learning transformer includes a hierarchical framing transformer, and
wherein the hierarchical framing transformer includes a feed forward neural network having multiple attention heads, wherein the feed forward neural network is trained via unsupervised learning.

3. The computing system of claim 2, wherein the feed forward neural network includes multiple layers, each of the multiple layers generating a separate sub-semantic embedding vector for each of the sequence of time ordered segments that identifies a sub-activity performed during the overarching activity.

4. The computing system of claim 1,
wherein the unsupervised machine learning transformer includes an unsupervised machine learning model that acts as a decoder and is configured to decode the semantic embedding vector to reconstruct the plurality of input vectors and obtain a plurality of reconstructed input vectors, and
wherein the unsupervised machine learning transformer performs unsupervised learning, based on the plurality of reconstructed input vectors and the plurality of input vectors, to adjust one or more weights applied to a plurality of subsequent input vectors when obtaining a subsequent single semantic embedding vector.

5. The computing system of claim 1, wherein the unsupervised machine learning transformer implements a variational auto encoder.

6. The computing system of claim 1, wherein the processing circuitry is further configured to perform preprocessing of the time-series data to condition the time-series data during generation of the plurality of input vectors.

7. The computing system of claim 1, wherein the processing circuitry is further configured to perform semantic enrichment with respect to the time-series data to condition the time-series data during generation of the plurality of input vectors.

8. The computing system of claim 1, wherein the processing circuitry is further configured to:
perform preprocessing of the time-series data to condition the time-series data to obtain a plurality of preprocessed embedded vectors; and
perform semantic enrichment with respect to the plurality of preprocessed embedded vectors to generate the plurality of input vectors.

9. The computing system of claim 1, wherein the processing circuitry is configured to:
perform activity detection with respect to the single semantic embedding vector to identify the activity; and
output an indication of the activity.

10. The computing system of claim 9, wherein the activity detection includes anomaly detection with respect to the single semantic embedding vector.

11. A method of performing activity detection, the method comprising:
processing, by an unsupervised machine learning transformer executed by a computing system, a plurality of input vectors representative of time-series data to obtain a sequence of time ordered segments that maintain time order of the plurality of input vectors;
encoding, by the unsupervised machine learning transformer, the sequence of time ordered segments to obtain a single semantic embedding vector that identifies an overarching activity occurring over at least a portion of the time-series data represented by the plurality of input vectors; and
outputting, by the unsupervised machine learning transformer, an indication of an activity detected based on the semantic embedding vector.

12. The method of claim 11,
wherein the unsupervised machine learning transformer includes a hierarchical framing transformer, and
wherein the hierarchical framing transformer includes a feed forward neural network having multiple attention heads, wherein the feed forward neural network is trained via unsupervised learning.

13. The method of claim 12, wherein the feed forward neural network includes multiple layers, each of the multiple layers generating a separate sub-semantic embedding vector for each of the sequence of time ordered segments that identifies a sub-activity performed during the overarching activity.

14. The method of claim 11,
wherein the unsupervised machine learning transformer includes an unsupervised machine learning model that acts as a decoder and is configured to decode the semantic embedding vector to reconstruct the plurality of input vectors and obtain a plurality of reconstructed input vectors, and
wherein the unsupervised machine learning transformer performs unsupervised learning, based on the plurality of reconstructed input vectors and the plurality of input vectors, to adjust one or more weights applied to a plurality of subsequent input vectors when obtaining a subsequent single semantic embedding vector.

15. The method of claim 11, wherein the unsupervised machine learning transformer implements a variational auto encoder.

16. The method of claim 11, further comprising performing preprocessing of the time-series data to condition the time-series data during generation of the plurality of input vectors.

17. The method of claim 11, further comprising performing semantic enrichment with respect to the time-series data to condition the time-series data during generation of the plurality of input vectors.

18. The method of claim 11, further comprising:
performing preprocessing of the time-series data to condition the time-series data to obtain a plurality of preprocessed embedded vectors; and
performing semantic enrichment with respect to the plurality of preprocessed embedded vectors to generate the plurality of input vectors.

19. The method of claim 11, further comprising:
performing activity detection with respect to the single semantic embedding vector to identify the activity; and
outputting an indication of the activity.

20. A non-transitory computer-readable storage medium having instructions stored thereon that, when executed, cause one or more processors to:
invoke an unsupervised machine learning transformer that:
processes a plurality of input vectors representative of time-series data to obtain a sequence of time ordered segments that maintain time order of the plurality of input vectors;
encodes the sequence of time ordered segments to obtain a single semantic embedding vector that identifies an overarching activity occurring over at least a portion of the time-series data represented by the plurality of input vectors; and
outputs the semantic embedding vector.
